(19) United States
(12) Patent Application Publication
(10) Pub. No.: US 2025/0304816 A1
(43) Pub. Date: Oct. 2, 2025

(54) IMMOBILIZED TWO-DIMENSIONAL COLLOID CRYSTAL AND METHOD FOR PRODUCING SAME

(71) Applicants: PUBLIC UNIVERSITY CORPORATION NAGOYA CITY UNIVERSITY, Nagoya-shi, Aichi (JP); MURATA MANUFACTURING CO., LTD., Nagaokakyo-shi, Kyoto (JP)

(72) Inventors: Junpei YAMANAKA, Nagoya-shi (JP); Akiko TOYOTAMA, Nagoya-shi (JP); Tohru OKUZONO, Nagoya-shi (JP); Minori FUJITA, Nagoya-shi (JP); Ami MATSUO, Nagoya-shi (JP); Marina TAKEMOTO, Nagoya-shi (JP); Tatsuya ISHIKAWA, Nagaokakyo-shi (JP); Koichiro HYODO, Nagaokakyo-shi (JP); Masaya NISHIDA, Nagaokakyo-shi (JP)

(73) Assignees: PUBLIC UNIVERSITY CORPORATION NAGOYA CITY UNIVERSITY, Nagoya-shi, Aichi (JP); MURATA MANUFACTURING CO., LTD., Nagaokakyo-shi, Kyoto (JP)

(21) Appl. No.: 18/866,049

(22) PCT Filed: May 11, 2023
(86) PCT No.: PCT/JP2023/017734

§ 371 Date: Nov. 14, 2024

(30) Foreign Application Priority Data
May 18, 2022 (JP) 2022-081351

(51) Int. Cl. C09D 133/26; C08K 3/36; C09D 7/61

(52) U.S. Cl. CPC C09D 133/26; C09D 7/61; C08K 3/36

(57) ABSTRACT

An object of the present invention is at least one of: 1) to provide a two-dimensional colloidal crystal having a hardly disturbed crystal structure, and a method for producing the same; and 2) to provide a two-dimensional colloidal crystal composed of a plurality of types of colloidal particles, and a method for producing the same.

In an immobilized two-dimensional colloidal crystal of the present invention, a colloidal crystal 2 formed of a single layer is immobilized on a substrate 1 by a resin 3. A method for producing an immobilized two-dimensional colloidal crystal of the present invention includes a substrate preparation step S1 of preparing a substrate, a colloidal crystal dispersion preparation step S2 of preparing a charged colloidal crystal dispersion, a colloidal crystal adsorption step S3 of bringing the charged colloidal crystal dispersion into contact with the substrate, a cleaning step S4 of cleaning the substrate to form a two-dimensional colloidal crystal, and an immobilization step S5 of immobilizing the two-dimensional colloidal crystal.

### TECHNICAL FIELD

The present invention relates to an immobilized two-dimensional colloidal crystal and a method for producing the same.

### BACKGROUND ART

The colloid is a state in which a dispersion phase is dispersed in a dispersion medium, and a liquid dispersion medium is referred to as colloidal dispersion. The “charged colloidal particles” having a charge on their surface align regularly and spontaneously with a distance in a dispersion of the charged colloidal particles when appropriate conditions are selected, due to electrostatic repulsive force acting between the particles. This structure is called a charged colloidal crystal.

The present inventors have succeeded in forming a two-dimensional charged colloidal crystal on a substrate from a liquid in which a charged colloidal crystal is dispersed, and have already filed a patent application (Patent Literature 1). The two-dimensional charged colloidal crystal refers to an ordered array structure in which colloidal particles align, with a distance, in a single layer on a plane by electrostatic repulsive force. The two-dimensional charged colloidal crystal is expected to be utilized as a functional surface in various fields such as sensing, photonics, and plasmonics. For example, two-dimensional colloidal crystals of gold particles are expected to be applied to analytical chemistry, biochemistry, material science, diagnosis in the medical field, and the like as sensing materials using surface plasmon or surface-enhanced Raman substrates. In addition, since a structure having a diffraction peak in ultraviolet to near-infrared regions can be easily produced using various particles, two-dimensional colloidal crystals are also useful in the optical field as alternatives to a two-dimensional diffraction grating. Furthermore, a functional electrode using metal particles, a highly efficient catalyst chip using semiconductor particles, and the like are also expected to be realized.

In a method for forming a two-dimensional charged colloidal crystal as described in Patent Literature 1, a two-dimensional charged colloidal crystal is formed in a self-organized manner as its charged colloidal particles attempt to have a thermodynamically stable structure. Therefore, the method has an advantage that no precise processing technique is necessary, unlike a lithographic method or the like. In addition, it can be used as a photonic material corresponding to various wavelengths by selecting a diameter of the colloidal particles.

### CITATIONS LIST

### Patent Literature

Patent Literature 1: JP 2020-34543 A

### SUMMARY OF INVENTION

### Technical Problems

However, in the method described in Patent Literature 1, the two-dimensional charged colloidal crystal is obtained in a state of being in contact with a liquid medium such as water, but there is a problem that the colloidal particles approach and aggregate each other by capillary force in a process of drying the crystal, resulting in a disturbed crystal structure.

In addition, even if the two-dimensional charged colloidal crystal is used in contact with a liquid medium such as water, there is a problem that it is difficult to use the two-dimensional charged colloidal crystal in a wider range as a material, for example, it is difficult to provide a plurality of reflection bands or absorption bands in reflection and transmission spectra, because the type of colloidal particles is only one.

The present invention has been made in light of the above-described conventional circumstances, and an object thereof is at least one of: 1) to provide a two-dimensional colloidal crystal having a hardly disturbed crystal structure, and a method for producing the same; and 2) to provide a two-dimensional colloidal crystal composed of a plurality of types of colloidal particles, and a method for producing the same.

### Solutions to Problems

In an immobilized two-dimensional colloidal crystal of the present invention, a colloidal crystal formed of a single layer is immobilized by a resin. For this reason, the movement of the colloidal particles constituting the two-dimensional colloidal crystal is restricted by the resin, and the crystal structure is hardly disturbed even if an external force is applied.

In the immobilized two-dimensional colloidal crystal of the present invention, the colloidal crystal may be formed on a substrate. In this case, the immobilized two-dimensional colloidal crystal can be easily produced by immobilizing the colloidal crystal formed on the substrate with a resin.

In the immobilized two-dimensional colloidal crystal of the present invention, a light transmissive substrate can be used from the viewpoint of use in the optical field, for example, as an alternative to a two-dimensional diffraction grating.

The resin for immobilizing the colloidal crystal is not particularly limited. For example, general-purpose polymeric resins such as an acrylic resin, a styrenic resin, an epoxy-based resin, a urethane-based resin, and a styrenic resin, silicone resins, biopolymers, and the like can be used. Among acrylic resins, polydialkylacrylamide is easily adsorbed onto colloidal particles such as silica, and therefore is easily immobilized, and can be particularly suitably used.

The type of the colloidal particles constituting the colloidal crystal is not particularly limited, and both inorganic particles and organic particles can be used. From the viewpoint of reducing lattice defects of the colloidal crystal, particle diameters of the colloidal particles are preferably as uniform as possible. Specifically, a coefficient of variation in particle diameter is preferably 20% or less, more preferably 15% or less, even more preferably 10% or less, and most preferably about 5% or less. Here, the coefficient of variation (CV) in particle diameter refers to a value of (standard deviation of particle diameter×100/average particle diameter).

When the immobilized two-dimensional colloidal crystal of the present invention is used as a material having high light transmittance such as a transmission-type diffraction grating, a refractive index of the resin and a refractive index of a light transmissive substrate are preferably as close as possible. For example, a value of (refractive index of resin/refractive index of light transmissive substrate) is preferably in a range of 0.9 to 1.1, and more preferably in a range of 0.95 to 1.05.

The two-dimensional colloidal crystal may be composed of a plurality of types of colloidal particles. In this case, a plurality of reflection bands or absorption bands can be provided in the reflection and transmission spectra, and the two-dimensional colloidal crystal can be used in a wider range as a material.

In addition, the colloidal crystal can have a crystal structure of a four-fold or six-fold symmetric pattern.

The immobilized two-dimensional colloidal crystal of the present invention can be produced by the following method.

Specifically, a method for producing a two-dimensional colloidal crystal according to the present invention is characterized by including: a substrate preparation step of preparing a substrate having a surface charge; a colloidal crystal dispersion preparation step of preparing a charged colloidal crystal dispersion in which a three-dimensional colloidal crystal composed of colloidal particles having a surface charge opposite in sign to a surface charge of the substrate is dispersed in a dispersion medium; a colloidal crystal adsorption step of bringing the charged colloidal crystal dispersion into contact with the substrate to adsorb the colloidal crystal on the substrate; a cleaning step of cleaning the substrate on which the colloidal crystal is adsorbed with a cleaning liquid to form a two-dimensional colloidal crystal formed of a single layer on the substrate; and an immobilization step of immobilizing the two-dimensional colloidal crystal by bringing the substrate on which the two-dimensional colloidal crystal is formed into contact with a resin solution and then drying the resin solution.

After the immobilization step is performed, a polymerizable monomer is further polymerized on the immobilized two-dimensional colloidal crystal, whereby the crystal structure of the immobilized two-dimensional colloidal crystal can be reinforced so as not to be disturbed. As the polymerizable monomer, a monomer to be polymerized by light or a monomer to be polymerized by heat can be used.

In the method for producing a colloidal crystal according to the present invention, after the cleaning step, a second colloidal particle adsorption step of bringing the substrate on which the two-dimensional colloidal crystal is formed into contact with a second colloidal particle dispersion in which second colloidal particles different in type from the colloidal particles are dispersed in a dispersion medium; and a cleaning step of cleaning the substrate on which the second colloidal particles are adsorbed are performed, and then the immobilization step is performed, thereby making it possible to obtain an immobilized two-dimensional colloidal crystal in which a two-dimensional colloidal crystal composed of two types of colloidal particles is immobilized. Here, the “immobilized two-dimensional colloidal crystal in which a two-dimensional colloidal crystal composed of two types of colloidal particles is immobilized” means that each of two types of colloidal particles forms a crystal lattice of a two-dimensional colloidal crystal, and, besides, one of colloidal particles of the other crystal lattice is located at a center position of the crystal lattice.

After the cleaning step is performed, the substrate is further brought into contact with a third colloidal dispersion in which third colloidal particles are dispersed, whereby an immobilized two-dimensional colloidal crystal in which the third colloidal particles are further adsorbed in a gap between particle arrays of the two types of colloidal particles already adsorbed onto the substrate can be obtained. Further, by further repeating the colloidal particle adsorption step and the cleaning step, an immobilized two-dimensional colloidal crystal composed of four or more types of colloidal particles can be obtained.

In the two-dimensional colloidal crystal of the present invention, a plurality of types of colloidal particles form a colloidal crystal formed of a single layer. In this case, a plurality of reflection bands or absorption bands can be provided in the reflection and transmission spectra, and the two-dimensional colloidal crystal can be used in a wider range as a material.

In addition, the two-dimensional colloidal crystal can have a crystal structure of a four-fold or six-fold symmetric pattern.

The two-dimensional colloidal crystal of the present invention can be produced by the following method.

Specifically, a method for producing the two-dimensional colloidal crystal is characterized by including:
a substrate preparation step of preparing a substrate having a surface charge;
a colloidal crystal dispersion preparation step of preparing a charged colloidal crystal dispersion in which a three-dimensional colloidal crystal composed of first colloidal particles having a surface charge opposite in sign to a surface charge of the substrate is dispersed in a dispersion medium;
a colloidal crystal adsorption step of bringing the charged colloidal crystal dispersion into contact with the substrate to adsorb the colloidal crystal on the substrate;
a cleaning step of cleaning the substrate on which the colloidal crystal is adsorbed with a cleaning liquid to form a two-dimensional colloidal crystal formed of a single layer on the substrate;
after the cleaning step, a colloidal particle adsorption step of bringing the substrate on which the two-dimensional colloidal crystal is formed into contact with a colloidal particle dispersion in which second colloidal particles different in type from the first colloidal particles are dispersed in a dispersion medium; and a second cleaning step of cleaning the substrate on which the second colloidal particles are adsorbed.

After the second cleaning step is performed, the substrate is further brought into contact with a third colloidal dispersion in which third colloidal particles are dispersed, whereby a two-dimensional colloidal crystal in which the third colloidal particles are further adsorbed in a gap between particle arrays of the two types of colloidal particles already adsorbed onto the substrate can be obtained. Further, by further repeating the colloidal particle adsorption step and the cleaning step, a two-dimensional colloidal crystal composed of four or more types of colloidal particles can be obtained.

### BRIEF DESCRIPTION OF DRAWINGS

FIG. 1 includes a schematic cross-sectional view (a) and schematic plan views (b) and (c) of a two-dimensional colloidal crystal of Embodiment 1.

FIG. 2 is a process diagram for producing an immobilized two-dimensional colloidal crystal of a six-fold symmetric pattern.

FIG. 3 is a schematic cross-sectional view of an apparatus for growing a colloidal crystal from one end side using a diffusion phenomenon in Embodiment 2.

FIG. 4 is a process diagram for producing an immobilized two-dimensional colloidal crystal of a four-fold symmetric pattern.

FIG. 5 includes schematic plan views and schematic cross-sectional views of a colloidal crystal (a) having a crystal structure of a four-fold symmetric pattern and a colloidal crystal (b) having a crystal structure of a six-fold symmetric pattern.

FIG. 6 is a graph showing a relationship between a size ratio d and volume fractions.

FIG. 7 is a process diagram showing a method for producing an immobilized two-dimensional colloidal crystal of Embodiment 3.

FIG. 8 shows optical micrographs of immobilized two-dimensional colloidal crystals of Examples 1 and 2 and Comparative Example 1.

FIG. 9 is a graph of a radial distribution function g(r) determined from optical micrographs before and after drying in Example 1.

FIG. 10 shows appearance photographs before and after drying in Example 1 and after drying in Comparative Example 1.

FIG. 11 shows an appearance photograph (a) and an optical micrograph (b) of an immobilized two-dimensional colloidal crystal of Example 3.

FIG. 12 is a schematic view of an apparatus used in a laser diffraction method.

FIG. 13 shows a projection photograph of a laser diffraction pattern for an immobilized two-dimensional colloidal crystal of Example 2.

FIG. 14 is a schematic partial cross-sectional view of a colloidal crystal preparation cell.

FIG. 15 shows an optical micrograph of a two-dimensional colloidal crystal (before immobilization) of Example 4.

FIG. 16 shows an optical micrograph of the two-dimensional colloidal crystal (after immobilization) of Example 4.

FIG. 17 shows an optical micrograph of a two-dimensional colloidal crystal (after immobilization by PDMA) of Example 5.

FIG. 18 shows an optical micrograph of the two-dimensional colloidal crystal (after immobilization by PDMA) of Example 5.

FIG. 19 shows an optical micrograph of a two-dimensional colloidal crystal (before immobilization by PDMA) of Example 6-1.

FIG. 20 shows an optical micrograph of the two-dimensional colloidal crystal (after immobilization by PDMA) of Example 6-1.

FIG. 21 shows optical micrographs of a two-dimensional colloidal crystal of Example 9 ((a) before immobilization, (b) after immobilization by PEG, and (c) after immobilization by PEG and polyvinyl morpholine).

FIG. 22 shows optical micrographs of a two-dimensional colloidal crystal of Example 10 ((a) after immobilization by PEG, and (b) after immobilization by PEG and polyvinyl morpholine).

FIG. 23 shows optical micrographs of a two-dimensional colloidal crystal of Example 11 ((a) before immobilization, and (b) after immobilization by Pluronic (registered trademark)).

FIG. 24 shows an optical micrograph of a two-dimensional colloidal crystal of Example 12 (after immobilization by Pluronic (registered trademark)).

### DESCRIPTION OF EMBODIMENTS

### Embodiment 1

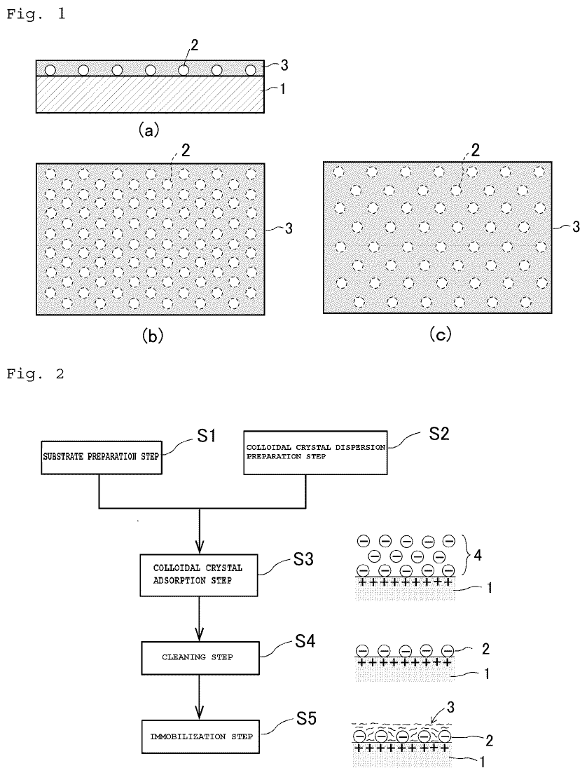

In an immobilized two-dimensional colloidal crystal of Embodiment 1, as shown in FIG. 1(a), colloidal particles 2 forming a two-dimensional colloidal crystal formed of a single layer are present on a substrate 1, and the colloidal particles 2 are immobilized by a resin 3. Therefore, movement of the colloidal particles 2 is prevented by the resin 3, and a crystal structure of the two-dimensional colloidal crystal is hardly disturbed. Even a product in a state in which the colloidal particles 2 are peeled off from the substrate 1 together with the resin 3 is the immobilized two-dimensional colloidal crystal of the present invention.

The type of the two-dimensional colloidal crystal may be a crystal structure of a six-fold symmetric pattern in which a (111) plane of a face-centered cubic lattice (FCC) is oriented as shown in FIG. 1(b), or a crystal structure of a four-fold symmetric pattern in which a (100) plane of a face-centered cubic lattice (FCC) is oriented as shown in FIG. 1(c).

A material for the substrate 1 is not particularly limited, and, for example, a ceramic substrate such as a glass plate or an alumina plate, a plastic substrate, a metal substrate, or the like can be used. As a material for the colloidal particles 2 constituting the colloidal crystal, any material having a positive or negative surface charge in a dispersion medium can be used. Examples of the colloidal particles include particles made of an inorganic substance (for example, SiO₂ particles, TiO₂ particles, and alumina particles), particles made of an organic substance (for example, polystyrene particles and acrylic polymer particles), and particles obtained by coating these particles with a metal (for example, SiO₂ particles coated with a metal). Metal particles (for example, noble metal particles such as Au particles, Pt particles, Pd particles, rhodium particles, iridium particles, ruthenium particles, osmium particles, and rhenium particles, Ag particles, and Cu particles) can also be used.

In addition, in order to adjust the surface charge of the colloidal particles, surface modification may be performed with a chemical modifier such as a silane coupling agent. In a dispersion of the colloidal particles, commercially available particles for colloids can be dispersed in an appropriate dispersion medium such as water, inorganic particles synthesized by a sol-gel method or the like can be used, or particles having relatively uniform sizes obtained by polymerizing a monomer such as styrene by emulsion polymerization or the like can be used as the colloidal particles.

Examples of the dispersion medium include water, but liquids other than water can also be used. For example, formamides (for example, dimethylformamide) and alcohols (for example, ethylene glycols) can be used. These may be mixed liquids with water.

In addition, the resin 3 that immobilizes the colloidal particles 2 may be any resin that is dissolved or dispersed in a dispersion medium, and, for example, a general-purpose polymeric resin such as an acrylic resin, a styrenic resin, an epoxy-based resin, or a urethane-based resin, a silicone resin, a biopolymer, or the like can be used.

### Embodiment 2

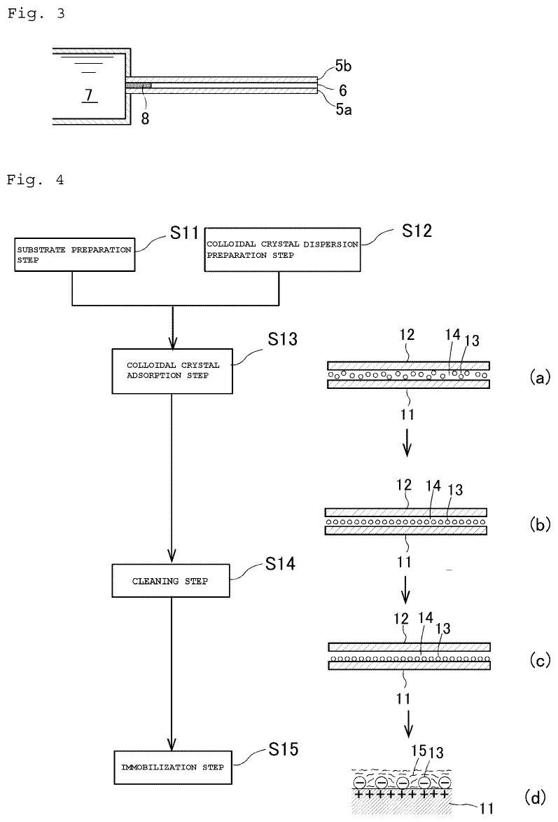

An immobilized two-dimensional colloidal crystal of Embodiment 2 has a crystal structure of a six-fold symmetric pattern, and is formed of a single layer in which a (111) plane of a face-centered cubic lattice (FCC) is oriented (see FIG. 1(b)). This immobilized two-dimensional colloidal crystal can be produced according to the steps shown in FIG. 2.

### (Substrate Preparation Step S1)

A substrate 1 made of glass, ceramics, plastic, or the like is prepared. The substrate 1 is required to have a positive or negative surface charge in a dispersion. In order to make the surface charge of the substrate positive or negative, an amino group, a sulfonic acid group, or the like may be introduced to the surface of the substrate by a chemical modifier.

### (Colloidal Crystal Dispersion Preparation Step S2)

On the other hand, a charged colloidal crystal dispersion in which a three-dimensional charged colloidal crystal is dispersed in a dispersion medium is prepared. Colloidal particles constituting the charged colloidal crystal are required to have a surface charge opposite in sign to the surface charge of the substrate 1. In order to make the surface charge of the colloidal particles positive or negative, an amino group or the like may be introduced to the surface of the colloidal particles by a chemical modifier.

### (Colloidal Crystal Adsorption Step S3)

By bringing the charged colloidal crystal dispersion prepared as described above into contact with the substrate 1, a three-dimensional charged colloidal crystal 4 of a six-fold symmetric pattern is adsorbed onto the substrate 1 by electrostatic attractive force. The contact method is not particularly limited, and examples thereof include a method of dropping the charged colloidal crystal dispersion onto the substrate 1 and a method of immersing the substrate in the charged colloidal crystal dispersion.

### (Cleaning Step S4)

Then, the substrate 1 is cleaned with a cleaning liquid. In this step, the three-dimensional charged colloidal crystal 4 of a six-fold symmetric pattern adsorbed onto the substrate 1 is washed away while only one layer on the substrate 1 is left. The reason why only one layer on the substrate remains is that the colloidal particles 2 having a surface charge opposite to the surface charge of the substrate 1 are strongly adsorbed onto the substrate 1 by electrostatic attractive force.

### (Immobilization Step S5)

Then, the substrate 1 on which the two-dimensional colloidal crystal of a six-fold symmetric pattern is formed is brought into contact with a solution of a resin composed of a polymer (hereinafter, referred to as “resin solution”). As a result, the resin 3 is adsorbed onto the substrate 1 and the colloidal particles 2. Further, by drying the resin solution, the resin 3 clings to the colloidal particles 2 and the substrate 1 to further firmly perform immobilization. Thus, the immobilized two-dimensional colloidal crystal of Embodiment 2 having a crystal structure of a six-fold symmetric pattern is obtained.

In the colloidal crystal adsorption step S3 in Embodiment 2, the method disclosed in Patent Literature 1 may be used. That is, as shown in FIG. 3, the method is a method in which a gap between two substrates 5a and 5b facing each other is filled with a charged colloidal dispersion 6, and a charge preparation liquid 7 is diffused from one end side to crystallize a charged colloidal crystal, thereby forming a charged colloidal crystal dispersion 8. Here, the charge preparation liquid 7 is a liquid capable of colloidally crystallizing charged colloidal particles in the charged colloidal dispersion 6. In this way, by gradually growing the crystal from one end side of the gap using a diffusion phenomenon, a charged colloidal crystal with less lattice defects are crystallized.

The charge preparation liquid 7 is not particularly limited as long as it is a liquid capable of colloidally crystallizing colloidal particles in the charged colloidal dispersion 6, and examples thereof include 1) surfactants such as an anionic surfactant solution, a cationic surfactant solution, a nonionic surfactant solution, and an amphoteric surfactant solution, 2) acids such as hydrochloric acid, sulfuric acid, phosphoric acid nitric acid, and carboxylic acid, and 3) alkali carbonates such as sodium carbonate, alkali hydrogen carbonates such as sodium hydrogen carbonate, alkali hydroxides such as sodium hydroxide, and bases such as aqueous ammonia, amine, and pyridine.

### Embodiment 3

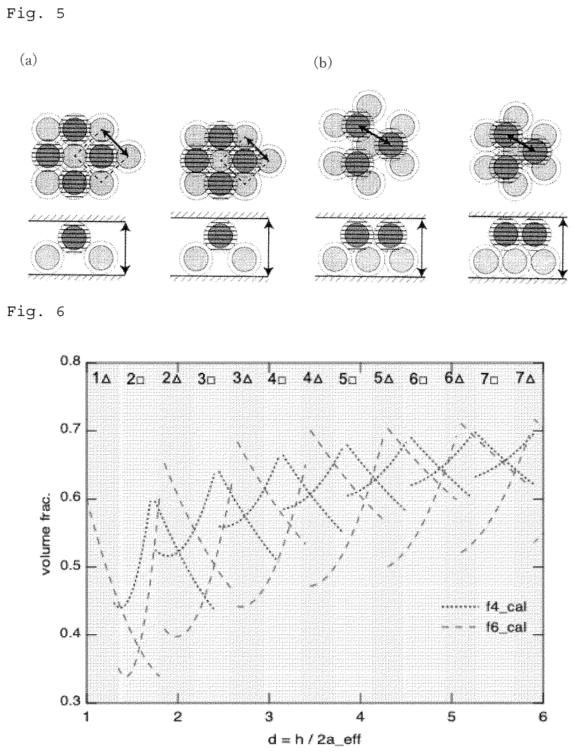

An immobilized two-dimensional colloidal crystal of Embodiment 3 has a crystal structure of a four-fold symmetric pattern, and is formed of a single layer of a (100) plane of FCC (face-centered cubic structure) (see FIG. 1(c)). This immobilized two-dimensional colloidal crystal can be produced according to the steps shown in FIG. 4. Details will be described below.

### (Substrate Preparation Step S11)

A substrate 11 and an opposed plate 12 which are made of glass, ceramics, plastic, or the like are prepared. The substrate 11 is required to have a positive or negative surface charge in a dispersion. In order to make the surface charge of the substrate 11 positive or negative, an amino group, a sulfonic acid group, a hydroxyl group, or the like may be introduced to its surface by a chemical modifier.

### (Colloidal Crystal Dispersion Preparation Step S12)

A charged colloidal crystal dispersion 14 in which a three-dimensional colloidal crystal is dispersed in a dispersion medium is prepared. Colloidal particles constituting the charged colloidal crystal have a surface charge opposite in sign to the surface charge of the substrate 11. In order to make the surface charge of the colloidal particles positive or negative, an amino group or the like may be introduced to the surface of the colloidal particles by a chemical modifier.

### (Colloidal Crystal Adsorption Step S13)

After the charged colloidal crystal dispersion is dropped onto the substrate 11 (or the opposed plate 12), the opposed plate 12 (or the substrate 11) is stacked thereon at a predetermined interval (see FIG. 4(a)). In order to set the interval between the substrate 11 and the opposed plate 12 to a predetermined interval, a spacer made of a sphere having a predetermined radius or a plate material having a predetermined thickness may be inserted between the substrate 11 and the opposed plate 12.

As time passes, a charged colloidal crystal is formed on the substrate 11 (FIG. 4(b)). In this case, the type of the charged colloidal crystal to be formed varies depending on a ratio of a distance (gap) h between the substrate 11 and the opposed plate 12 to a particle diameter (=2a) of the colloidal particles. Therefore, controlling the distance (gap) h between the substrate 11 and the opposed plate 12 makes it possible to selectively obtain an immobilized two-dimensional colloidal crystal having a crystal structure of a four-fold symmetric pattern.

This can be derived from theoretical calculation. That is, the colloidal particles are assumed to be rigid bodies, and a (111) or (100) plane of the FCC structure is assumed to be taken so that a density of the colloidal particles in a constrained space is maximized. In addition, an interaction between the colloidal particles is approximated with a high-pressure limit in which a pressure p depends only on a size h of the gap as shown in Equation (1), also in consideration of only rigid sphere potential.

$$\begin{matrix}[ Math . 1 ] & \\ p = g Δ μ {\int }_{0}^{h} ρ dz = g Δμ \overline{ρ} h & ( 1 )\end{matrix}$$

In the equation, g is gravitational acceleration, Δμ is a density difference between the colloidal particles and the dispersion medium, and ρ is a volume fraction of the colloidal particles. In this model, a crystal structure of a four-fold symmetric pattern and a crystal structure of a six-fold symmetric pattern are subjected to geometrical calculation to determine the volume fractions. An inter-particle distance is r, a radius of the colloidal particles is a, and d equals to r/2a. A schematic view of the crystal structure of a four-fold symmetric pattern is shown in FIG. 5(a). In the same layer, when the inter-particle distance is larger than the particle diameter, particles in different layers are in contact with each other but particles in the same layer are not in contact with each other. In the same layer, when the inter-particle distance is equal to the particle diameter, a maximum filling rate of the colloidal particles determined by the following equation (2) is 0.74.

$$\begin{matrix}[ Math . 2 ] & \\ {d}_{n □} = 1 + ( n - 1 ) / \sqrt{2} & ( 2 )\end{matrix}$$

In the equation, □ indicates a crystal structure of a four-fold symmetric pattern. As a result, a volume fraction ρ_{n□} of the colloidal particles in the case of forming the crystal structure of a four-fold symmetric pattern can be determined by the following equation (3).

$$\begin{matrix}[ Math . 3 ] & \\ d < {d}_{n □} ; {ρ}_{n □} = \frac{π}{6} {\frac{η}{d} [ \frac{2 - {( d - 1 )}^{2}}{{( {d}_{n □} - 1 )}^{2}} - 1 ]}^{- 1} \\ d = {d}_{n □} ; {ρ}_{n □}^{*} = \frac{π}{6} \frac{n}{{d}_{n □}} = {\frac{π \sqrt{2}}{6} [ 1 + \frac{\sqrt{2} - 1}{n} ]}^{- 1} < 0.74 \\ d \geq {d}_{n □} ; {ρ}_{n □} = \frac{π}{6} \frac{n}{d} & ( 3 )\end{matrix}$$

Similarly, in the crystal structure of a six-fold symmetric pattern, in the same layer, when the inter-particle distance is larger than the colloidal particle diameter, colloidal particles in different layers are in contact with each other, but particles in the same layer are not in contact with each other (FIG. 5(b)). In the same layer, when the inter-particle distance is equal to the colloidal particle diameter, d_{nΔ} is expressed by the following equation (4). In the equation, Δ represents a crystal structure of a six-fold symmetric pattern.

$$\begin{matrix}[ Math . 4 ] & \\ {d}_{n Δ} = 1 + ( n - 1 ) \sqrt{2 / 3} & ( 4 )\end{matrix}$$

As a result, a volume fraction ρnΔ of the colloidal particles in the case of forming the crystal structure of a six-fold symmetric pattern can be determined by the following equation (5).

$$\begin{matrix}[ Math . 5 ] & \\ d < {d}_{n Δ} ; {ρ}_{n Δ} = \frac{π}{6} {\frac{2 n}{3 \sqrt{3} d} [ 1 - \frac{{( d - 1 )}^{2}}{{( n - 1 )}^{2}} ]}^{- 1} \\ d = {d}_{n Δ} ; {ρ}_{n Δ}^{*} = \frac{π}{6} \frac{2 n}{\sqrt{3} {d}_{n Δ}} = {\frac{π \sqrt{2}}{6} [ 1 + \frac{\sqrt{\frac{2}{3}} - 1}{n} ]}^{- 1} < 0.74 \\ d \geq {d}_{n Δ} ; {ρ}_{n Δ} = \frac{π}{6} \frac{2 n}{\sqrt{3} d} & ( 5 )\end{matrix}$$

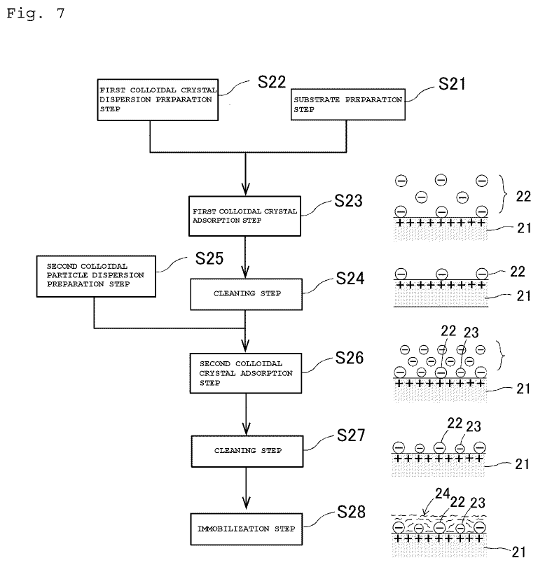

FIG. 6 shows a graph obtained by determining and plotting a size ratio d and the volume fractions from the equations (3) and (5) (dotted lines with fine spacing show a volume fraction change with respect to d of the crystal structure of a four-fold symmetric pattern, and dotted lines with coarse spacing show a volume fraction change with respect to d of the crystal structure of a six-fold symmetric pattern). The higher the particle density, the more stable the crystal structure is. Therefore, a phase diagram is obtained by separation at a place where the magnitude relationship of the density of the colloidal particles changes between the crystal structure of a four-fold symmetric pattern and the crystal structure of a six-fold symmetric pattern. That is, it can be seen that, as a value of h/2a increases, phase transitions occur in the order of a crystal structure of a six-fold symmetric pattern formed of two layers (2Δ)→a crystal structure of a four-fold symmetric pattern formed of three layers (3□)→a crystal structure of a six-fold symmetric pattern formed of three layers (3Δ)→a crystal structure of a four-fold symmetric pattern formed of four layers (4□)→a crystal structure of a six-fold symmetric pattern formed of four layers (4Δ).

From the above results, by controlling the distance between the substrate 11 and the opposed plate 12, the crystal structure of the colloidal crystal can be made into a crystal structure of a four-fold symmetric pattern or a crystal structure of a six-fold symmetric pattern. Even if the substrate 11 and the opposed plate 12 are not parallel but inclined, or the substrate 11 and the opposed plate 12 are deflected and thus the value of h/2a changes depending on the location, it is possible to partially form a crystal structure of a four-fold symmetric pattern.

The surface charge of the colloidal particles varies due to the presence of a minor amount of salt (ionic impurity) in the dispersion medium. Therefore, the dispersion medium is preferably sufficiently desalinated in the preparation of the dispersion of colloidal particles. For example, in the case of using water, first, dialysis is performed on purified water until an electric conductivity of water used is about the same as the value before use, and then desalination purification is performed by keeping a sufficiently washed ion exchange resin (mixed bed of cation and anion exchange resins) coexisting in a sample for at least one week.

However, after desalination purification is performed in this way, salts may be intentionally added, and desalination is performed later to crystallize a colloidal crystal.

The particle diameter of the colloidal particles and distribution thereof are preferably considered. The particle diameter of the colloidal particles is preferably 2000 nm or less, and more preferably 1000 nm or less. This is because, in the case of colloidal particles having a large particle diameter exceeding 2000 nm, the colloidal particles are hardly affected by Brownian motion, and self-organized colloidal crystallization hardly occurs. In addition, this is because particles having a large specific gravity are likely to settle due to the influence of gravity, resulting in deteriorated stability of the dispersion of the colloidal particles. A coefficient of variation in particle diameter of the colloidal particles (that is, a value obtained by dividing a standard deviation of the particle diameter by an average particle diameter) is preferably within 20%, more preferably 10% or less, and most preferably 5% or less. This is because, when the coefficient of variation in particle diameter increases, it becomes difficult for the colloidal crystals to crystallize, lattice defects and nonuniformity of the colloidal crystals increase, and it becomes difficult to obtain high-quality colloidal crystals.

### (Cleaning Step S14)

The thus crystallized charged colloidal crystal having a crystal structure of a four-fold symmetric pattern is electrostatically adsorbed (see FIG. 4(c)). As a method for electrostatic adsorption, a method can be adopted in which the surface of the substrate 11 or the colloidal particles 13 is modified with, for example, a silane coupling agent having an amino group, an alkali such as NaOH, sodium hydrogen carbonate, or sodium carbonate is added to a dispersion medium, and the substrate 11 and the opposed plate 12 are immersed in water to remove cations existing between the substrate 11 and the opposed plate 12 by diffusion or convection. By removing cations, the pH of the dispersion medium is lowered, and the amino group is ionized, whereby the surface charge is made positive. Therefore, the colloidal particles 13 are adsorbed onto the substrate 11 by electrostatic attractive force. The thus obtained charged colloidal crystal having a crystal structure of a four-fold symmetric pattern is adsorbed onto the substrate 11 by electrostatic attractive force, and is stably immobilized without moving even when immersed in pure water. When an ion exchange resin is placed in water in which the substrate and the opposed plate are to be immersed, removal of cations can be promoted.

### (Immobilization Step S15)

Finally, the substrate 11 on which the two-dimensional colloidal crystal of a four-fold symmetric pattern is thus formed is brought into contact with the resin solution. As a result, the resin 15 is adsorbed onto the substrate 11 and the colloidal particles 13, and the two-dimensional colloidal crystal of a four-fold symmetric pattern is immobilized. Further, by drying the resin solution, the resin 14 clings to the two-dimensional colloidal crystal of a four-fold symmetric pattern and the substrate 11 to firmly perform immobilization. Thus, the immobilized two-dimensional colloidal crystal of Embodiment 3 having a crystal structure of a four-fold symmetric pattern is obtained.

### Embodiment 4

An immobilized two-dimensional colloidal crystal of Embodiment 4 is an immobilized two-dimensional colloidal crystal composed of two types of colloidal particles 22 and 23, and can be produced according to the steps shown in FIG. 7.

First, as in Embodiment 2, a substrate preparation step S21, a first colloidal crystal dispersion preparation step S22, a colloidal crystal adsorption step S23, and a cleaning step S24 are performed. However, in the first colloidal crystal dispersion preparation step S22, a concentration of the colloidal particles in the dispersion medium is controlled to be a predetermined concentration. Here, the predetermined concentration means that the concentration is controlled so that each of the two types of colloidal particles 22 and 23 forms a crystal lattice of a two-dimensional colloidal crystal, and, besides, that one of colloidal particles of the other crystal lattice is located at a center position of the crystal lattice.

Then, the second colloidal particle dispersion preparation step S25, the colloidal crystal adsorption step S26, and the cleaning step S27 are further performed in the same manner. However, the colloidal particles 23 used in the second colloidal particle dispersion preparation step S25 are different in particle diameter and/or material from the colloidal particles 22 used in the first colloidal crystal dispersion preparation step S22. The colloidal particles 23 used in the second colloidal particle dispersion preparation step S25 need not be colloidally crystallized.

Finally, as an immobilization step S28, the substrate 21 is brought into contact with the resin solution, and then the resin solution is dried, so that the resin 24 clings to the two-dimensional colloidal crystal composed of the colloidal particles 22 and the colloidal particles 23 and the substrate 21 to firmly perform immobilization. Thus, an immobilized two-dimensional colloidal crystal 25 composed of the two types of colloidal particles 22 and 23 is obtained.

### EXAMPLES

### Fixation of Two-Dimensional Colloidal Crystal Having Crystal Structure of Six-Fold Symmetric Pattern

### Example 1, Example 2, and Comparative Example 1

### Substrate Preparation Step

The surface of a cover glass for optical microscope (manufactured by Matsunami Glass Ind., Ltd.) was modified with a silane coupling agent (3-aminopropyltrimethoxysilane), and an aminopropyl group was introduced into the glass surface to obtain a cover glass having a positive surface charge. A silicone sheet (thickness: 5 mm) provided with a hole of 1 cm×1 cm was placed on the cover glass to provide a recess.

### Colloidal Crystal Dispersion Preparation Step

An aqueous dispersion of silica particles (KE-P100 manufactured by Nippon Shokubai Co., Ltd., particle diameter d=1060 nm) in an amount of 6 vol. % was prepared, and an ion exchange resin (BioRad AG501-X8 (D), 20 to 50 mesh) was added for desalination to obtain an aqueous dispersion of a three-dimensional charged colloidal crystal in which silica particles regularly aligned in water by electrostatic repulsive force.

### Colloidal Crystal Adsorption Step

The aqueous dispersion of the three-dimensional charged colloidal crystal was placed in the recess of the cover glass.

### Cleaning Step

The recess was cleaned with Milli-Q water, and then about 200 μL of Milli-Q water remained.

### Immobilization Step

Further, 500 μL of an aqueous solution of polydimethylacrylamide (PDMA, molecular weight: 144000, synthesized by a radical polymerization method) having a predetermined concentration was added to the recess, and mixed with a pipette. Then, drying was performed in an oven at 40° C. overnight to evaporate moisture, thereby obtaining immobilized two-dimensional colloidal crystals of Examples 1 and 2. The amount of PDMA added was 1.25 mg/cm² in Example 1 and 0.1 mg/cm² in Example 2. In addition, as Comparative Example 1, the same operation was performed in the case where PDMA was not added.

### —Evaluation—

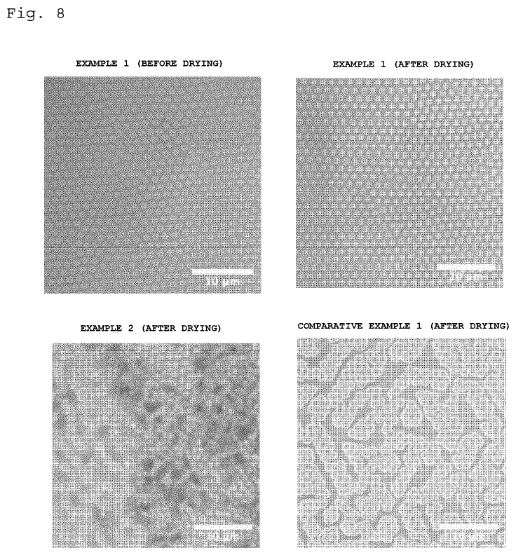

The immobilized two-dimensional colloidal crystals of Examples 1 and 2 and Comparative Example 1 obtained as described above were observed with an inverted optical microscope from the back side of the cover glass. The results are shown in FIG. 8. In Example 1, it was found that the silica particles formed a two-dimensional colloidal crystal of a six-fold symmetric pattern before drying, and the crystal structure was retained without being disturbed even after drying. Also in Example 2, it was found that a two-dimensional colloidal crystal of a six-fold symmetric pattern was retained although the crystal structure was somewhat disturbed after drying. On the other hand, in Comparative Example 1 without addition of PDMA, it was confirmed that the silica particles aggregated due to drying and that the crystal structure was disturbed. This is because a capillary attractive force acts between the silica particles in the drying process, so that the particles aggregated each other.

In addition, a radial distribution function g(r) (r is a center-to-center distance of the particles) was determined by performing image processing of the micrographs before and after drying in Example 1. The results are shown in FIG. 9. An average inter-particle distance determined from a first peak position of g(r) was 1.55±0.06 μm before drying and 1.54±0.03 μm after drying, which were consistent within the measurement error range. From this fact, it was found that the crystal structure was retained even upon drying.

When the thickness of the PDMA layer is calculated with the specific gravity of PDMA being 0.964 as a value of the monomer, the thickness is 13 μm in Example 1, which is sufficiently larger than the particle diameter (about 1 μm) of the silica particles, and it is 1.04 μm in Example 2, which is almost the same as the particle diameter of the silica particles.

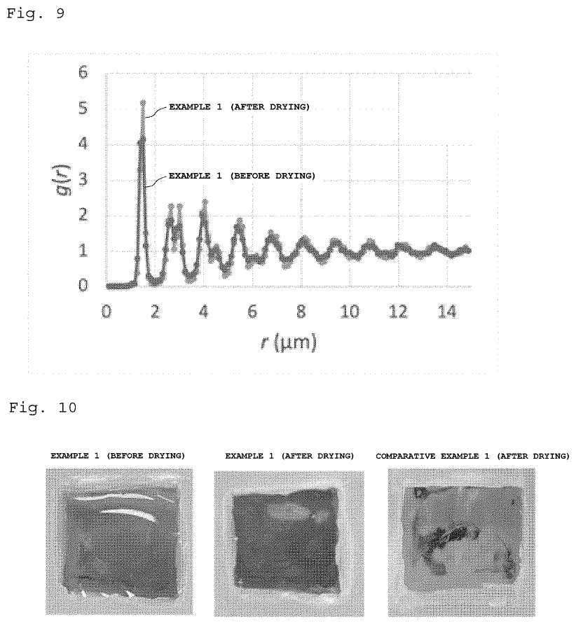

FIG. 10 shows appearance photographs before and after drying in Example 1 and after drying in Comparative Example 1. In Example 1, a structural color was observed both before and after drying. On the other hand, in Comparative Example 1, no structural color was observed after drying. The results are explained as follows. That is, in the two-dimensional colloidal crystal of Example 1, as shown in FIG. 8, the crystal structure is not disturbed not only before drying but also after drying. Since the diffraction wavelength based on this crystal structure is in the visible range, the incident light is diffracted and the structural color is observed. On the other hand, in Comparative Example 1, since the crystal structure is disturbed by drying, diffraction becomes incomplete, and the structural color disappears.

However, in the dried crystal, the medium around the particles is not water (refractive index nr=1.33) but PDMA (nr=1.47 for the DMA monomer), which is close to the refractive index of silica (nr=1.43), and thus the color development after drying in Example 1 is weaker than that before drying.

### Example 3

In Example 3, the immobilized two-dimensional colloidal crystal after drying was further firmly immobilized by photopolymerization of a DMA monomer.

That is, a silicon sheet provided with a hole of 2 cm square was placed on the substrate to form a recess. An immobilized colloidal crystal was produced in the recess in the same manner as in Example 1 (however, the concentration of PDMA was 0.25 wt. %, and the amount of PDMA dropped into the recess was 1.5 mL). Then, 600 μL of a liquid obtained by dissolving VA-086 (Wako Pure Chemical Industries, Ltd.) as a photoradical polymerization initiator in a dimethylacrylamide (DMA) monomer at a concentration of 6.67 mg/mL was added to the recess. The liquid was irradiated with UV to photopolymerize DMA. Thereafter, the liquid was heated in an oven at 80 to 100° C. to evaporate an unreacted DMA monomer. In this way, the immobilized two-dimensional colloidal crystal of Example 1 after drying was further fixed and strengthened with a PDMA resin having a thickness of about several millimeters. As a result, it exhibited the structural color as shown in FIG. 11(a). In addition, it was found that the crystal structure was maintained by microscopic observation (FIG. 11(b)). The average inter-particle distance was 1.59±0.01 μm.

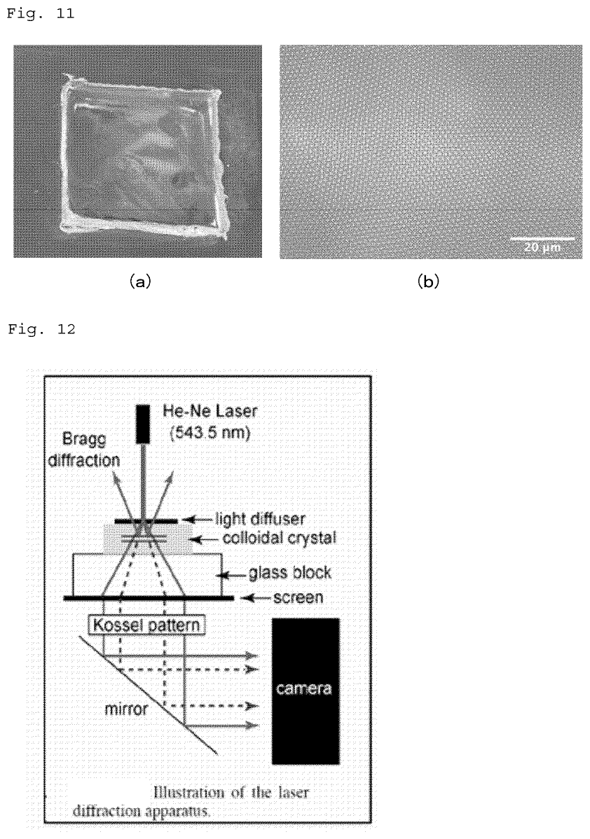

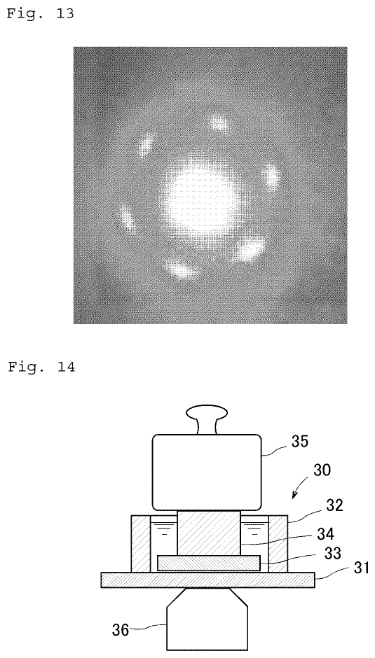

In addition, with respect to the immobilized two-dimensional colloidal crystal of Example 1, the structure of the two-dimensional colloidal crystal was evaluated by a laser diffraction method (a schematic diagram of an apparatus used in the laser diffraction method is shown in FIG. 12). A laser beam (helium-neon laser) was scattered in a conical shape by a light diffuser, and the immobilized two-dimensional colloidal crystal of Example 2 was irradiated with the laser beam. A diffraction pattern was projected on a screen provided on a lower surface of a glass block. The diffraction pattern was then observed using an optical mirror and photographed with a camera. As a result, as shown in FIG. 13, diffraction spots derived from a crystal structure of a six-fold symmetric pattern were clearly confirmed.

### Fixation of Two-Dimensional Colloidal Crystal Having Crystal Structure of Four-Fold Symmetric Pattern

### Example 4

In Example 4, a colloidal crystal was crystallized in a narrow gap with controlled spacing, thereby producing a two-dimensional colloidal crystal having a crystal structure of a four-fold symmetric pattern.

First, as a cell for crystallizing a colloidal crystal, a colloidal crystal preparation cell 30 shown in FIG. 14 was produced. In this cell, a silicon sheet 32 having a thickness of 5 mm and provided with a square hole of 2 cm×2 cm is caused to adhere to a glass substrate 31 surface-modified with 3-aminopropyltrimethoxysilane. In addition, a colloidal crystal dispersion composed of an alkaline silica dispersion obtained by mixing 100 μl of silica particles, d=1000 nm (KE-P100, 28 vol. %) and 70 μl of NaOH (0.01 M) was prepared. The colloidal crystal dispersion was dropped onto the surface-modified glass substrate 31, a plastic plate 33 was placed thereon, and a glass block 34 and a weight 35 were placed on the plastic plate 33. By changing the weight of the weight 35, spacing of a gap formed between the glass substrate 31 and the plastic plate 33 was adjusted. Since the colloidal crystal dispersion is alkaline, the amino group modifying the glass substrate is not ionized, the surface charge of the glass substrate is negative due to the silanol group on the glass surface, and the surface charge of the silica particles is also negative, so that the silica particles are not adsorbed onto the glass substrate.

Next, an ion exchange resin was added to a gap between the plastic plate 33 and the colloidal crystal preparation cell 30 and left for 3 days. As a result, the alkali in the colloidal crystal dispersion was removed by ion exchange. For this reason, since the amino group on the surface of the glass substrate 31 is ionized and the surface charge becomes positive, a colloidal crystal composed of silica particles having a negative surface charge are adsorbed onto the glass substrate 31.

Then, excess colloidal crystal dispersion and ion exchange resin were washed away using Milli-Q water. A micrograph of the glass substrate 31 thus obtained is shown in FIG. 15. From this micrograph, it was found that a two-dimensional colloidal crystal having a crystal structure of a four-fold symmetric pattern was formed on the glass substrate 31. The average inter-particle distance of the two-dimensional colloidal crystals was 1.28 μm.

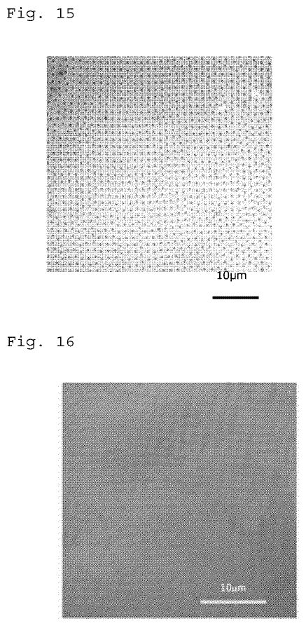

Then, PDMA was further added in a proportion of 1.25 mg/cm² and dried to obtain an immobilized two-dimensional colloidal crystal (the operation is the same as that in Example 3, and will not be described). When the thus obtained immobilized two-dimensional colloidal crystal was observed with an optical microscope, it was found that the crystal structure of a four-fold symmetric pattern before immobilization was maintained without being disturbed, as shown in FIG. 16.

### Fixation of Two-Component Two-Dimensional Colloidal Crystal Having Crystal Structure of Four-Fold Symmetric Pattern

### Example 5

In Example 5, a two-dimensional colloidal crystal composed of two types of colloidal particles and having a crystal structure of a four-fold symmetric pattern was prepared and immobilized.

First, a two-dimensional colloidal crystal having a crystal structure of a four-fold symmetric pattern before immobilization with PDMA was prepared by the same method as in Example 4. Then, about 1 mL of water was left in the colloidal crystal preparation cell 30, 100 μL of a dispersion of colored silica particles (particle diameter: 500 nm, green fluorescent color) was added thereto, and the mixture was lightly stirred and allowed to stand for 24 hours. In this way, the colloidal crystal was adsorbed onto the glass substrate 31, an ion exchange resin was then added to a gap between the plastic plate 33 and the colloidal crystal preparation cell 30, and the mixture was allowed to stand for 3 days. Then, the colloidal crystal was observed with an optical microscope from the back side of the glass substrate 31.

The results are shown in FIG. 17. FIGS. 17(a) and 17(b) are micrographs obtained by photographing the same field of view, and FIG. 17(c) is an overlay of FIGS. 17(a) and 17(b) (the first component is colored in red). FIG. 17(d) is a micrograph of another field of view. The average inter-particle distance was 1.38 μm for both the silica particles as the first component and the silica particles as the second component.

From the above results, it was found that a two-dimensional colloidal crystal having a crystal structure of a four-fold symmetric pattern composed of the first component and adsorbed onto the glass substrate 31 and a two-dimensional colloidal crystal having a crystal structure of a four-fold symmetric pattern composed of the second component were formed at shifted positions, and the colloidal particles as the second component were located at the centers of the lattices formed by the colloidal particles as the first component.

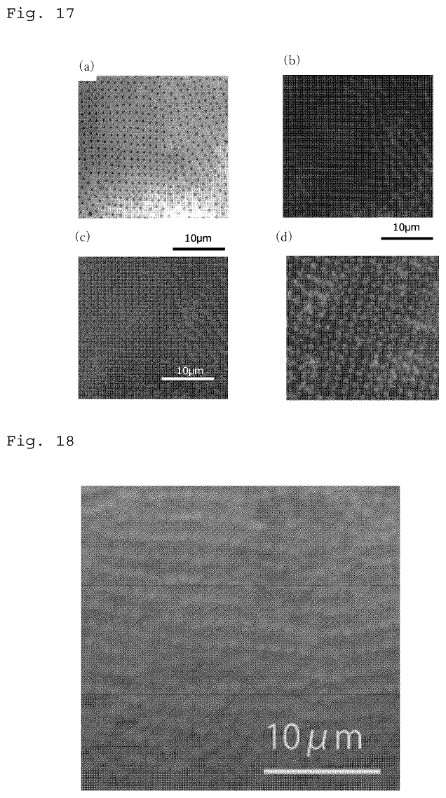

Furthermore, a two-dimensional colloidal crystal composed of two components was immobilized using PDMA (amount thereof added: 1.25 mg/cm²) by the same method as in Example 1, and microscopically observed from the back side of the glass substrate 31. As a result, as shown in FIG. 18, it was found that the crystal structure (see FIG. 17) before immobilization with PDMA was retained.

### Fixation of Two-Component Two-Dimensional Colloidal Crystal Having Crystal Structure of Six-Fold Symmetric Pattern

### Examples 6-1 and 6-2 and Comparative Example 1

In Examples 6-1 and 6-2 and Comparative Example 1, a two-dimensional colloidal crystal composed of two types of colloidal particles and having a crystal structure of a six-fold symmetric pattern was prepared and immobilized.

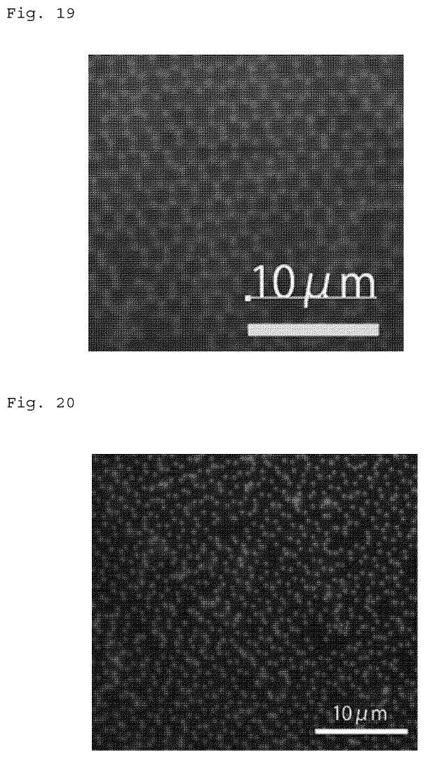

First, a colloidal crystal of silica particles (KE-P100, d=1060 nm) was fixed to a substrate by the method of Example 1 to produce a one-component two-dimensional colloidal crystal having a crystal structure of a six-fold symmetric pattern (however, the concentration of silica particles in the aqueous dispersion of silica particles was 6 vol. % in Example 6-1, 9 vol. % in Example 6-2, and 0.5 vol. % in Comparative Example 1). Next, 100 μL of an aqueous dispersion of silica particles (Micromod, Sicastar 500, d=467 nm) stained with a green fluorescent dye was added, and the mixture was lightly stirred and allowed to stand for 24 hours. Thereafter, the colloidal crystal was observed with a fluorescence microscope from the back side of the glass substrate 31. The results in Example 6-1 are shown in FIG. 19. In this fluorescence microscopic observation, only the particles as the second component (that is, silica particles stained with a green fluorescent dye and having an average particle diameter of 467 nm) are observed as bright circles, and the particles as the first component (that is, silica particles not fluorescently stained and having an average particle diameter of 1060 nm) are observed as black circles. From FIG. 19, it was found that silica particles having an average particle diameter of 467 nm as the second component were disposed between the silica particles having an average particle diameter of 1060 nm as the first component. The center-to-center distance of the silica particles as the first component was 1.67 μm.

In Example 6-2 and Comparative Example 1, the same fluorescence microscopic observation was performed. As a result, in Example 6-2, the same crystal structure as in Example 6-1 was observed, and the center-to-center distance of the silica particles as the first component was 1.55 μm. However, in Comparative Example 1, the same crystal structure as in Example 6-1 was not observed, a plurality of silica particles as the second component existed between the particles as the first component, and no clear crystal lattice was observed. The center-to-center distance of the silica particles as the first component was 1.78 μm.

From the above results, it was found that the distance between the silica particles as the first component can be controlled by appropriately adjusting the dispersion concentration of the silica particles in the aqueous dispersion of silica particles as the first component. Further, it was found that, by appropriately adjusting the dispersion concentration of the silica particles in the aqueous dispersion of the silica particles as the first component, it is possible to form a two-dimensional colloidal crystal having a crystal structure of a six-fold symmetric pattern composed of the first component adsorbed onto the glass substrate 31 and also having a crystal structure of a six-fold symmetric pattern composed of the second component.

In Example 6-1, a two-dimensional colloidal crystal composed of two components was immobilized using PDMA (amount thereof added: 1.25 mg/cm2) in the same manner as in Example 1, and observed with a fluorescence microscope from the back side of the glass substrate 31. As a result, as shown in FIG. 20, it was found that the crystal structure (see FIG. 19) before immobilization with PDMA was retained.

### Fixation of Two-Dimensional Colloidal Crystal with Styrenic Resin

### Example 7

In Example 7, a two-dimensional colloidal crystal was fixed with a styrenic resin. Details will be described below.

A substrate preparation step, a colloidal crystal dispersion preparation step, a colloidal crystal adsorption step, and a cleaning step were performed in the same manner as in Example 1. The recess was cleaned with Milli-Q water, and then about 200 μL of Milli-Q water remained.

### Styrenic Monomer Solution Adjustment Step

A monomer solution composed of 95 wt. % of a styrene monomer and 5 wt. % of ethylbenzene was stirred while being retained at room temperature. Furthermore, 1,1-di-t-butylperoxy-3,3,5-trimethylcyclohexane as a radical polymerization initiator was added at 0.21×10⁻³ mol/L, and the mixture was stirred to obtain a polymerization initiator-containing styrene monomer solution.

### Immobilization Step

To the recess was added 500 μL of the polymerization initiator-containing styrene monomer solution. The solution was mixed with a pipette. Then, drying was performed in an oven at 145° C. for 1 hour to evaporate moisture, and observation with the naked eye and observation with an optical microscope were performed. As a result, it was found that the colloidal crystal was an immobilized two-dimensional colloidal crystal exhibiting the same structural color as in Example 1 and having a crystal structure of a six-fold symmetric pattern.

### Fixation of Two-Dimensional Colloidal Crystal with (Meth)Acrylic Resin

### Example 8

In Example 8, a two-dimensional colloidal crystal was fixed using trimethylolpropane triacrylate as a (meth)acrylic resin. Details will be described below.

A substrate preparation step, a colloidal crystal dispersion preparation step, a colloidal crystal adsorption step, and a cleaning step were performed in the same manner as in Example 1. The recess was cleaned with Milli-Q water, and then about 200 μL of Milli-Q water remained.

### (Meth)Acrylic Resin Solution Adjustment Step

A (meth)acrylic resin solution having the following mixing ratio was stirred while being retained at room temperature.
Trimethylolpropane triacrylate: 90 parts by weight
Pentaerythritol tetrakis(3-mercaptobutyrate) 1: 10 parts by weight
Irgacure184: 2 parts by weight

### Immobilization Step

To the recess was added 500 μL of the above-described (meth)acrylic resin solution. The solution was mixed with a pipette. Further, photopolymerization was performed by UV irradiation, and drying was then performed in an oven at 100° C. for 1 hour to evaporate moisture. Observation with the naked eye and observation with an optical microscope were performed. As a result, it was found that the colloidal crystal was an immobilized two-dimensional colloidal crystal exhibiting the same structural color as in Example 1 and having a crystal structure of a six-fold symmetric pattern.

### Fixation of Two-Dimensional Colloidal Crystal with PEG and Polyvinyl Morpholine

### Example 9

In Example 9, a two-dimensional colloidal crystal was fixed with polyethylene glycol (PEG) and polyvinyl morpholine. Details will be described below.

A two-dimensional silica colloidal crystal having a crystal structure of a six-fold symmetric pattern was prepared by performing a substrate preparation step, a colloidal crystal dispersion preparation step, a colloidal crystal adsorption step, and a cleaning step in the same manner as in Example 1 (see FIG. 21(a)).

### Immobilization Step

In an immobilization step, a two-stage immobilization method was performed, in which immobilization was first performed using polyethylene glycol, and then further immobilization was performed using polyvinyl morpholine.

That is, first, 50 μL of an aqueous solution of polyethylene glycol (PEG, molecular weight: 35000, 3 wt. %) was added to the recess, and mixed with a pipette. The concentration of the aqueous PEG solution was adjusted so as to be 1.5 mg/cm² during drying. Then, drying was performed in an oven at 40° C. overnight to evaporate moisture, thereby obtaining immobilized two-dimensional colloidal crystal (see FIG. 21(b)).

Furthermore, after nitrogen bubbling was performed on N-vinylmorpholine for 1 minute, a solution to which VA086 was added as a photopolymerization initiator so as to attain 0.5 mg/mL was added dropwise to each cell in an amount of 500 μL, and fixation was performed by irradiation with UV light for 1 hour. As a result of microscopic observation after photocuring, it was found that the structure of the two-dimensional crystal having a crystal structure of a six-fold symmetric pattern was maintained as it was (see FIG. 21(c)). In the photographs of FIGS. 21(a), 21(b), and 21(c), each side is 26 μm.

### Example 10

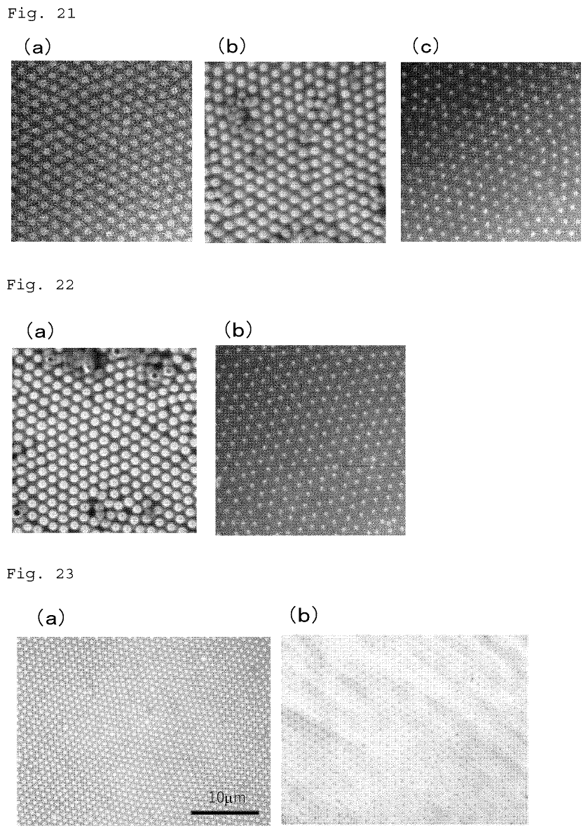

In Example 10, PEG having a molecular weight of 100000 was used in the immobilization step. The others are the same as in Example 9. Microscopic observation after immobilization with PEG showed that a two-dimensional colloidal crystal having a crystal structure of a six-fold symmetric pattern was formed (see FIG. 22(a)). As a result of microscopic observation after photocuring, it was found that the structure of the two-dimensional crystal having a crystal structure of a six-fold symmetric pattern was maintained as it was (see FIG. 22(b)). In the photographs of FIGS. 22(a) and 22(b), each side is 26 μm.

### Fixation of Two-Dimensional Colloidal Crystal by Pluronic (Registered Trademark)

### Example 11

In Example 11, polystyrene particles were used as colloidal particles, and in the immobilization step, Pluronic (registered trademark) (that is, a triblock copolymer of poly(ethylene glycol)-block-poly(propylene glycol)-block-poly(ethylene glycol)) was used for immobilization. Details will be described below.

### Substrate Preparation Step

The surface of the cover glass was surface-modified with an aminopropyl group in the same manner as in Example 1, and then a plastic 8-cell (each cell is a 1 cm×1 cm square) frame was caused to adhere thereto.

### Colloidal Crystal Dispersion Preparation Step

An aqueous dispersion of polystyrene particles (diameter: 430 nm, model number: No. 5043B, Thermo) in an amount of 10 vol. % was prepared, and an ion exchange resin (BioRad AG501-X8 (D), 20 to 50 mesh) was added for desalination to obtain an aqueous dispersion of a three-dimensional charged colloidal crystal in which polystyrene particles regularly aligned in water by electrostatic repulsive force.

The colloidal crystal adsorption step and the cleaning step are the same as those in Example 1.

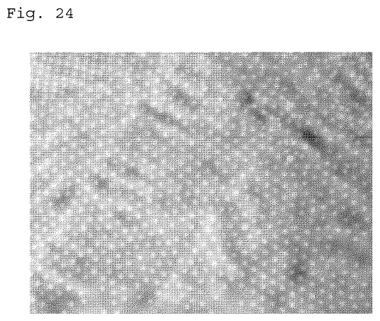

An optical micrograph after cleaning is shown in FIG. 23(a). From this micrograph, it was found that a two-dimensional colloidal crystal having a crystal structure of a six-fold symmetric pattern was formed.

### Immobilization Step

To the cell was added 394 μL of Pluronic (registered trademark) (molecular weight: 8400, ALDRICH) aqueous solution having a concentration of 3.165 mg/mL, and the cell was placed in an oven at 40° C. and dried for 2 days. Microscopic observation after immobilization showed that an immobilized two-dimensional colloidal crystal having a crystal structure of a six-fold symmetric pattern was formed (see FIG. 23(b)).

In the immobilized two-dimensional colloidal crystal of Example 11, hydrophobic polystyrene particles are used as the colloidal particles, and hydrophilic glass is used as the substrate. Pluronic (registered trademark) used for immobilization has a hydrophilic poly(ethylene glycol) chain and a hydrophobic poly(propylene glycol) chain. For this reason, the poly(propylene glycol) chain is adsorbed onto the surface of the hydrophobic polystyrene particles, and the poly(propylene glycol) chain is adsorbed onto the glass surface of the hydrophilic substrate, so that the two-dimensional colloidal crystal composed of the polystyrene particles is firmly fixed to the substrate surface via Pluronic (registered trademark).

### Example 12

In Example 12, an aqueous solution (concentration: 3.185 mg/ml) of Pluronic (registered trademark) (ALDRICH) having a molecular weight of 14600 was used in the immobilization step. Other operations and conditions are the same as those in Example 11. Microscopic observation after immobilization showed that a two-dimensional colloidal crystal having a crystal structure of a six-fold symmetric pattern was formed (see FIG. 24).

### Fixation of Two-Dimensional Colloidal Crystal Composed of Polystyrene Particle

### Example 13

In Example 13, a two-dimensional colloidal crystal using polystyrene particles instead of silica particles was immobilized. Details will be described below.
The substrate preparation step was performed in the same manner as in Example 1.

### Colloidal Crystal Dispersion Preparation Step

An aqueous dispersion of polystyrene particles (Thermo, coefficient of variation in particle diameter=2.2%, negatively charged) having a diameter of 1000 nm was concentrated to prepare a 6 vol. % aqueous dispersion, and an ion exchange resin (BioRad AG501-X8 (D), 20 to 50 mesh) was added for desalination to obtain an aqueous dispersion of a three-dimensional charged colloidal crystal in which polystyrene particles regularly aligned in water by electrostatic repulsive force.
The colloidal crystal adsorption step, the cleaning step, and the immobilization step were performed in the same manner as in Example 1. The obtained solidified body was observed with the naked eye and observed with an optical microscope. As a result, it was found that the colloidal crystal was an immobilized two-dimensional colloidal crystal exhibiting the same structural color as in Example 1 and having a crystal structure of a six-fold symmetric pattern.

The present invention is not limited to the description of the embodiments and examples of the invention. Various modifications that can be easily conceived by those skilled in the art without departing from the scope of the claims are also included in the present invention.

### INDUSTRIAL APPLICABILITY

Since the crystal structure of the two-dimensional colloidal crystal of the present invention is hardly disturbed, the two-dimensional colloidal crystal is suitable in the case of being applied to sensing, photonics, plasmonics, and the like as a functional surface.

### REFERENCE SIGNS LIST

S1, S11, S21 . . . Substrate preparation step
S2, S12 . . . Colloidal crystal dispersion preparation step
S22 . . . First colloidal crystal dispersion preparation step
S3, S13 . . . Colloidal crystal adsorption step
S23 . . . First colloidal crystal adsorption step
S25 . . . Second colloidal particle dispersion preparation step
S26 . . . Second colloidal crystal adsorption step
S4, S14, S24, S27 . . . Cleaning step
S5, S15, S28 . . . Immobilization step
5a, 5b, 11, 21 . . . Substrate
12 . . . Opposed plate
2, 13, 22, . . . Colloidal particle
23 . . . Second colloidal particle
14, 24 . . . Resin
6 . . . Charged colloidal dispersion
7 . . . Charge preparation liquid

1-15. (canceled)

16. An immobilized two-dimensional colloidal crystal having a crystal structure of a four-fold symmetric pattern, in which a colloidal crystal formed of a single layer is immobilized by a resin.

17. The immobilized two-dimensional colloidal crystal according to claim 16, wherein the colloidal crystal is formed on a substrate.

18. The immobilized two-dimensional colloidal crystal according to claim 17, wherein the substrate is a light transmissive substrate.

19. The immobilized two-dimensional colloidal crystal according to claim 16, wherein the resin is an acrylic resin or a styrenic resin.

20. The immobilized two-dimensional colloidal crystal according to claim 19, wherein the resin is polydialkylacrylamide.

21. The immobilized two-dimensional colloidal crystal according to claim 16, wherein colloidal particles constituting the colloidal crystal are silica or polystyrene.

22. The immobilized two-dimensional colloidal crystal according to claim 18, wherein a value of (refractive index of the resin/refractive index of the light transmissive substrate) is in a range of 0.9 to 1.1.

23. The immobilized two-dimensional colloidal crystal according to claim 16, wherein the colloidal crystal is composed of a plurality of types of colloidal particles.

24. A method for producing an immobilized two-dimensional colloidal crystal, comprising:
a substrate preparation step of preparing a substrate having a surface charge;
a colloidal crystal dispersion preparation step of preparing a charged colloidal crystal dispersion in which a three-dimensional colloidal crystal composed of colloidal particles having a surface charge opposite in sign to a surface charge of the substrate is dispersed in a dispersion medium;
a colloidal crystal adsorption step of bringing the charged colloidal crystal dispersion into contact with the substrate to adsorb the colloidal crystal on the substrate;
a cleaning step of cleaning the substrate on which the colloidal crystal is adsorbed with a cleaning liquid to form a two-dimensional colloidal crystal formed of a single layer on the substrate; and
an immobilization step of immobilizing the two-dimensional colloidal crystal by bringing the substrate on which the two-dimensional colloidal crystal is formed into contact with a resin solution and then drying the resin solution.

25. The method for producing an immobilized two-dimensional colloidal crystal according to claim 24,
wherein, after the cleaning step, a second colloidal particle adsorption step of bringing the substrate on which the two-dimensional colloidal crystal is formed into contact with a second colloidal particle dispersion in which second colloidal particles different in type from the colloidal particles are dispersed in a dispersion medium; and
a cleaning step of cleaning the substrate on which the second colloidal particles are adsorbed are performed, and then the immobilization step is performed.

26. The method for producing an immobilized two-dimensional colloidal crystal according to claim 24, wherein, after the immobilization step is performed, a polymerizable monomer is further polymerized on the immobilized two-dimensional colloidal crystal.

27. A two-dimensional colloidal crystal having a crystal structure of a four-fold symmetric pattern, in which a plurality of types of colloidal particles form a colloidal crystal formed of a single layer.

28. A method for producing a two-dimensional colloidal crystal in which a plurality of types of colloidal particles form a colloidal crystal formed of a single layer, comprising:
a substrate preparation step of preparing a substrate having a surface charge;
a colloidal crystal dispersion preparation step of preparing a charged colloidal crystal dispersion in which a three-dimensional colloidal crystal composed of first colloidal particles having a surface charge opposite in sign to a surface charge of the substrate is dispersed in a dispersion medium;
a colloidal crystal adsorption step of bringing the charged colloidal crystal dispersion into contact with the substrate to adsorb the colloidal crystal on the substrate;
a cleaning step of cleaning the substrate on which the colloidal crystal is adsorbed with a cleaning liquid to form a two-dimensional colloidal crystal formed of a single layer on the substrate;
after the cleaning step, a colloidal particle adsorption step of bringing the substrate on which the two-dimensional colloidal crystal is formed into contact with a colloidal particle dispersion in which second colloidal particles different in type from the first colloidal particles are dispersed in a dispersion medium; and
a second cleaning step of cleaning the substrate on which the second colloidal particles are adsorbed.
